(19) United States
(12) Patent Application Publication
(10) Pub. No.: US 2014/0100964 A1
(43) Pub. Date: Apr. 10, 2014

(54) METHODS AND SYSTEMS FOR CREATING MARKETING CAMPAIGNS

(71) Applicants: Jerry Neal Kramer, (US); Frank Cabot Woolley, (US); John Claud Monro, (US)

(72) Inventors: Jerry Neal Kramer, (US); Frank Cabot Woolley, (US); John Claud Monro, (US)

(73) Assignee: Zelephant Holdings, LLC, Las Vegas, NV (US)

(21) Appl. No.: 13/646,295

(22) Filed: Oct. 5, 2012

(51) Int. Cl. G06Q 30/02

(52) U.S. Cl. 705/14.66

(57) ABSTRACT

A computer-implemented method is provided. The method includes providing a plurality of contacts, wherein each contact is associated with at least one attribute, and filtering the plurality of contacts based on the at least one attribute. The method also includes generating, using a processor, a production for each contact in the filtered plurality of contacts, wherein the production includes at least one collateral item selected from a plurality of collateral items, wherein the at least one collateral item is selected based on a variable content replacement. The method further includes transmitting the production using at least one outbound channel. A graphical user interface is also provided for creating, managing, and monitoring the marketing campaign.

### BACKGROUND

The field of the invention relates generally to methods and systems for use with marketing campaigns, and more particularly, to methods and systems for use in creating and managing marketing campaigns.

Modern marketing campaigns are often data-driven and multi-channel. Some campaigns aim to target customized messages to individuals based on information known or assumed about the individual. Such customized messages may be delivered using one or more channels, such as web, print, email, direct mail, text messages, and social networks. Some campaigns include a variety of assets that can be customized depending on the individual and the channel. For example, different text can be emailed to two different individuals, or different images can be used on different channels, such as websites and social networks.

Creating a marketing campaign that is data-driven, targeted, and multi-channel is labor intensive. Managing the data associated with possible recipients and the assets for each targeted message can be burdensome. Accordingly, there is a need for methods and systems for creating marketing campaigns by compiling and identifying recipients, customizing messages, selecting the most effective channel for a recipient, and measuring the effectiveness of a campaign.

### BRIEF DESCRIPTION

In one embodiment, a computer-implemented method is provided. The method includes receiving a plurality of contacts, wherein each contact is associated with at least one attribute, and filtering the plurality of contacts based on the at least one attribute. The method also includes generating, using a processor, a production for each contact in the filtered plurality of contacts, wherein the production includes at least one collateral item selected from a plurality of collateral items, wherein the at least one collateral item is selected based on a variable content replacement. The method further includes transmitting the production using at least one outbound channel.

In another embodiment, a marketing system is provided. The marketing system includes a processing device programmed to receive a plurality of contacts, wherein each contact is associated with at least one attribute, and filter the plurality of contacts based on the at least one attribute. The processing device is also programmed to generate a production for each contact in the filtered plurality of contacts, wherein the production includes at least one collateral item selected from a plurality of collateral items, wherein the at least one collateral item is selected based on a variable content replacement. The processing device is further programmed to transmit the production using at least one outbound channel.

In yet another embodiment, one or more non-transitory computer-readable storage media having computer-executable instructions embodied thereon are provided. When executed by at least one processing device, the computer-executable instructions cause the at least one processing device to receive a plurality of contacts, wherein each contact is associated with at least one attribute, and filter the plurality of contacts based on the at least one attribute. The computer-executable instructions also cause the at least one processing device to generate a production for each contact in the filtered plurality of contacts, wherein the production includes at least one collateral item selected from a plurality of collateral items, wherein the at least one collateral item is selected based on a variable content replacement. The computer-executable instructions further cause the at least one processing device to transmit the production using at least one outbound channel.

### BRIEF DESCRIPTION OF THE DRAWINGS

FIG. 1 is a block diagram of an exemplary system for use in creating and managing marketing campaigns.

FIG. 2 is an exemplary interface for use with the system shown in FIG. 1.

FIG. 3 is a flowchart of an exemplary method for using the system shown in FIG. 1.

FIG. 4 is a block diagram showing representative computing devices that may be used to implement the systems of FIG. 1.

### DETAILED DESCRIPTION

Methods and systems described herein enable a marketing system user to create dynamic marketing campaigns using available data and available channels. The marketing system generates targeted messages, delivers the targeted messages to intended recipients, and detects a response of the intended recipients. Using a graphical user interface, a marketing system user is able to craft a marketing campaign without knowledge of the underlying data and/or systems.

When implemented, a technical effect of the embodiments described herein include: (a) receiving a plurality of contacts, wherein each contact is associated with at least one attribute, (b) filtering the plurality of contacts based on the at least one attribute, (c) generating, using a processor, a production for each contact in the filtered plurality of contacts, wherein the production includes at least one collateral item selected from a plurality of collateral items, wherein the at least one collateral item is selected based on a variable content replacement, and (d) transmitting the production using at least one outbound channel.

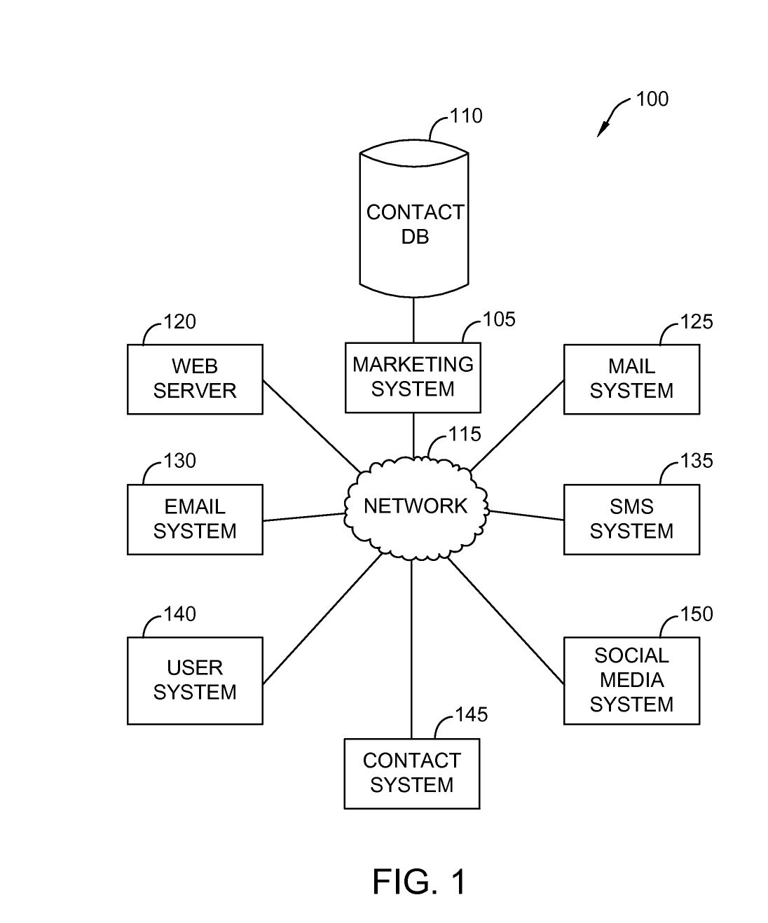

FIG. 1 is a block diagram of an exemplary system 100 for use in creating and managing marketing campaigns. The system 100 includes various systems that may be used together or independently. In some implementations, one or more systems or components shown in FIG. 1 may be combined into a single system or distributed across multiple systems. The system 100 includes a marketing system 105 that is communicatively coupled to a contact database 110. The marketing system 105 is connected to a network 115 that may include one or more segments, including LANs, WANs, and/or the Internet.

The network 115 is connected to a web server 120, a mail system 125, an email system 130, and a short message service (SMS) system 135. The network 115 is also connected to a user system 140, a contact system 145, and a social media system 150. One or more servers, systems, or components of the system 100 may be implemented using a computing device, as described in more detail herein.

The marketing system 105 is configured to communicate with the contact database 110, the web server 120, the mail system 125, the email system 130, the SMS system 135, the user system 140, the contact system 145, and the social media system 150. The marketing system 105 may communicate with other servers, systems, or components of the system 100 using an application programming interface (API), protocols such as HTTP and SOAP, and/or any protocol or information exchange methodology. In the exemplary embodiment, the marketing system 105 provides a web interface that users can use to create, manage, and measure marketing campaigns.

The marketing system 105 uses contact lists to coordinate and monitor campaigns. Contact lists include one or more contacts, who are each individuals, companies or otherwise. Contact lists are stored in contact database 110 as individual contact records, and may include, for each contact, contact information, name(s), gender, age, birthday, and other profile information. For example, contact lists may include loyalty club information, including a loyalty club member number, loyalty club member level, and loyalty club activity. Contact database 110 includes historical information about each contact, such as changes to information about a contact. Contact lists may be uploaded or transferred to the marketing system 105 for storage in the contact database 110. The marketing system 105 is configured to match and associate the same contact in different contact lists or within a single contact list. By combining one or more contact lists, the marketing system 105 can create new contact lists.

The web server 120 is configured to, among other things, provide landing pages for marketing campaigns. Landing pages may be customized for individual contacts, or generic for a campaign. Customized pages may be reached by using a personalized Uniform Resource Locator (URL). A personalized URL may contain a word, name, token, or other identifier that associates the personalized URL with a contact. For example, the personalized URL may contain a filename or query string that includes an identifier. In the exemplary embodiment, the personalized URL includes an identifier in the hostname. For example, the personalized URL of http://johndoe.campaign.com may be personalized for John Doe. In order to include an identifier in the hostname, a Domain Name System (DNS) server may be modified to respond to all queries for a subdomain and/or to one or more subdomains that include predetermined identifiers. The DNS server may direct personalized hostnames to the web server 120, which may be configured to use virtual hosts or some other method to accommodate personalized hostnames.

Landing pages, as will be explained in more detail herein, are part of a campaign. The URL for a landing page, whether generic or personalized, may be included as a link in an email, SMS, web page, or other electronic message, or printed, displayed, or otherwise communicated via print, television, radio, billboards, or other media. Landing page URLs may be communicated as barcodes, quick response (QR) codes, or other optically recognized formats.

The mail system 125 is configured to receive electronic orders for print mailings, or direct mail. The electronic orders may include recipient information, such as a name and address, format information, and/or print information. For example, the electronic order may include an indication that the format is a postcard and may include the contents to be printed on the postcard. The marketing system 105 is configured to generate and transmit electronic orders to the mail system 125. Each mailing, including the printed content, generated by the mail system 125 may be personalized for each recipient. The mailings may include a URL to a landing page. The mail system 125 may be configured to frank, pre-sort, and/or place the mailings in condition for acceptance by a postal system.

The email system 130 may be configured to receive email as a server or relay, such as a Simple Mail Transport Protocol (SMTP) server, and/or may be configured to receive data for use in generating and sending emails. Similar to the mail system 125, the email system 130 may receive, from the marketing system 105, data that includes recipient and content information. The recipient information may include an email address and, optionally, a name. The content information may include text, images, and/or attachments for an email. The emails, whether generated by the marketing system 105 or the email system 130, may be customized for each contact. More specifically, the content of each email, including any URLs, may be customized for each contact.

The SMS system 135 is configured to communicate with mobile devices via SMS or other mobile device communication message, such as a Multimedia Messaging Service (MMS) message. The SMS system 135 is configured to transmit messages to mobile devices, which may be the contact system 145, associated with contacts. The messages may be personalized for each contact and may include a URL to a landing page. The URL may be a personalized URL. The SMS system 135 may also be configured to receive messages from mobile devices. For example, a SMS message may be used to add a person to a contact list. More specifically, a specialized number may be published in combination with one or more keywords that, if sent to the specialized number, may cause the sending mobile device to be added to a contact list associated with the one or more keywords.

The social media system 150 provides a social media service that enables users to make connections with each other, share messages and content such as images, interact publicly or privately, and/or otherwise contribute and consume data socially. Examples of social media services include, but are not limited to, Facebook and Twitter. Facebook is a registered trademark of Facebook Inc. and Twitter is a registered trademark of Twitter, Inc. The social media system 150 may allow users to post content, send messages, and/or create advertisements.

The marketing system 105 is configured to communicate with the social media system 150 such that the marketing system 105 may post content, send messages, and/or create advertisements. More particularly, the marketing system 105 may post links to landing pages, send customized messages to users, and/or create advertisements. The marketing system 105 may create advertisements that are customized for one or more subsets of the users of the social media service. The marketing system 105 may also be configured to authorize payment for advertisements on the social media service. The marketing system 105 may also receive messages, content, and/or interactions from the social media system 105. For example, the marketing system 105 may receive and process a notification that a user of the social media system 150 liked or shared content posted by the marketing system 105. The content posted by the marketing system 150 may include URLs to landing pages, including personalized URLs.

The user system 140 may be used by a user of the marketing system 105 to interact with the marketing system 105. More specifically, the user system 140 may include a web browser that is used to connect to a web interface provided by the marketing system 105. The user system 140 may be used to create, manage, and monitor campaigns using the marketing system 105.

The contact system 145 is used by a contact to receive emails from the email system 130, communicate with the social media system 150, visit landing pages provided by the web server 120, and/or interact with the marketing system 105. For example, a contact may receive an email from the email system 130 using the contact system 145. The contact may follow a link in the email to a landing page on the web server 120.

The marketing system 105 is configured to create and coordinate marketing campaigns using the system 100. More specifically, the marketing system 105 is configured to create, manage, and measure marketing campaigns. A user, e.g., using the user system 140, may create a campaign using the marketing system 105. A campaign includes one or more productions that are associated with a contact list.

A production is a collection of collateral, or collateral items, that is sent to a contact through a channel as part of a campaign. Collateral refers to the templates, media, images, and/or text needed to create the production. Collateral can be images, barcodes, links, survey questions, physical inventory items, etc. Collateral may be provided by the user (e.g., by uploading) and/or the marketing system 105. For example, an email is a production that is made up of collateral such as text and images, and is delivered to the contact through an email channel. The marketing system 105 enables a user to create and edit productions. The marketing system 105 may provide templates or other selectable resources.

A production channel can be an email, SMS, specialized SMS number, mailing, social media, landing page, etc. In other words, production channels may be either outbound (directed to a contact) or inbound (an action taken by a contact). The production channels are linked together to form a workflow, or logical path, within a campaign. In one example, an email is sent to a contact list. The email includes a link to a landing page. The landing page gathers contact information that can be transmitted to the contact database 110 or the user. In another example, a printed banner advertisement at a bus stop provides a QR code. When a person scans the QR code with a mobile device, e.g., the contact system 145, the mobile device is directed to a landing page. In another example, a mailing is sent to a contact. The mailing includes a coupon for an item to be redeemed at an establishment. The contact uses the coupon to obtain the item and no information is sent back to the marketing system 105.

A production can be customized for one or more contacts in a contact list. A variable content replacement (VCR) is a case statement that will place a possibly different piece of collateral in the production. For example, an email channel might use three different images: a first image for “gold” members, a second image for “silver” members, and a third image for non-rated members. This might be written as:
if player_level=gold then apply image “X”
   if player_level=silver then apply image “Y” else apply image “Z”

Thus, the user can customize the production for one or more contacts in a contact list. One or more VCRs may be used to customize a production using data associated with contacts in a contact list. Boolean, regular, or other expressions may be used to express a VCR. The marketing system 105 may provide a graphical interface of dropdowns, radio buttons, and other tools for building and applying VCRs to contact lists.

Productions may further include customizable fields that are populated with data from one or more sources. For example, a production may include fields that are replaced by a contact's name, as supplied by the contact database 110. The production may include fields that are replaced by a number of loyalty points, as supplied by a loyalty system database or server (not shown). The customizable fields may, like the VCRs, be driven by rules.

A production may be directed to a campaign contact list created by the user using the marketing system 105. A contact list for a campaign may be created from one or more contact lists in the contact database 110. Using logical operations like AND and set operations like unions, the user may create a live query that the marketing system 105 uses to combine one or more contact lists and/or omit contacts. A live query is used to identify a segment or target audience for a campaign. For example, a user may create a campaign contact list of contacts who have changed their player level in the last month. As another example, a user may create a campaign contact list of contacts within an age range living within several specified states.

The marketing system 105 may continuously monitor the contact database 110 for changes using one or more live queries. Unlike ordinary queries, which may be executed only once in order to identify a segment for a campaign, live queries may be executed more than once, with new or additional results being added to an existing identified segment. Live queries may be executed at predetermined time intervals or upon the addition of new information to the contact database 110. For example, live queries may identify newly added contacts or contacts whose information has changed. A contact may provide additional information to the contact database 110, e.g., through taking a survey, wherein the additional information causes the contact to be added to a campaign through a live query. Thus, contacts may be included in ongoing campaigns even if a contact was not present or did not match a live query when the campaign began.

Moreoever, the marketing system 105 may be configured to receive and store offers. Offers are bargains, deals, or other promotions that may be offered to contacts who match predetermined criteria. A user may create an offer and provide the predetermined criteria to the marketing system. Similar to live queries, the marketing system 105 identifies contacts who match the criteria on an ongoing basis. If a contact matches the offer criteria, the offer may be included in a production sent to the contact.

Thus, the marketing system 105 is configured to create productions that may have variable content and to create campaign contact lists based on live queries. The creation of campaign contact lists enable a campaign to be directed to a desired audience. Productions enable customized or personalized collateral to be delivered to each contact on the campaign contact list.

For each outbound channel associated with a campaign, a production may be created. For example, a production may be created for an email channel, and a production may be created for a direct mail channel. The marketing system 105 will determine which production to use based on which channel is most appropriate for a contact. More specifically, if no email address is available for a contact, the marketing system 105 may use direct mail to reach the contact. The marketing system 105 may select a channel for a contact based on a past response rate of the contact for the channel. For example, if a contact has responded most often to emails, the marketing system 105 may select an email channel for the contact and will use the corresponding email production.

For campaigns with inbound channels, the marketing system 105 may be configured to automatically associate an inbound channel with a campaign or outbound channel. For example, if a production includes a link to a landing page associated with a campaign, the marketing system 105 may detect when the landing page is visited, and associate each visit with the campaign, an outbound channel, and/or a contact associated with the campaign. More specifically, the marketing system 105 includes an identifier with a production to identify a response to the production via one or more inbound channels. The identifier enables the marketing system 105 to detect responses by specific contacts, via specific outbound channels, and/or via specific inbound channels. In other words, the marketing system 105 is configured to detect which contact responded to which outbound channel. The identifier may be included in a personalized URL or other URL such that the identifier is passed to the web server 120 when a contact visits a landing page. Information relating to the landing page visit is transmitted to the marketing system 105. In the case of social media channels, the marketing system 105 may associate a post with a campaign, detect responses to the post, and associate the responses to the campaign and/or contacts associated with the campaign.

The marketing system 105 is configured to detect and store responses received on inbound channels. More particularly, the marketing system 105 associates responses with a campaign and/or a contact. By detecting and storing responses, the marketing system 105 can measure the effectiveness of a campaign, a production, a channel, a campaign contact list, etc. The marketing system 105 may be used to create landing pages and/or other inbound channels. The marketing system 105 creates associations between the inbound channels and the campaign and/or contact such that responses can be associated with a campaign and/or a contact.

In some implementations, the marketing system 105 may use two or more productions for an outbound channel. The marketing system 105 may use A/B testing to determine which production has the highest response rate. The marketing system 105 may perform A/B testing on a subset of a campaign contact list, and use the production with the highest response rate on the remainder of the campaign contact list.

The user may monitor or measure a campaign's effectiveness using the marketing system 105. The marketing system 105 may generate reports, statistics, and other data associated with the responses received to a campaign. And so, the marketing system 105 is configured to generate customized or personalized productions for each contact in a campaign contact list. The campaign contact list is generated based on live queries to narrow the audience. The productions may be tailored to the outbound channel used to reach the contact, and the outbound channel may be selected for each contact based on available contact information and past success with a channel for that contact. The productions may include identifiers that enable the marketing system 105 to detect if messages are read, interacted with, responded to, etc. The marketing system 105 uses responses and inbound channels like landing pages to determine which contacts are responding, which outbound channels are being responded to, and which productions are being responded to. Accordingly, the marketing system 105 is capable of measuring the success of a campaign in varying levels of granularity.

During an example operation of the marketing system 105, Brand X Company (i.e., the user of the user system 140) has chosen to send out a campaign to its new subscribers to welcome them to the new rewards program that just launched. Brand X transmits a listing of all their contacts to the marketing system 105 as well as all needed production collateral, such as an image. Brand X would like the bulk of the campaign to first go to any of their contacts with an email address, followed by mailings. Within the email productions, Brand X would like to have a personalized URL that directs the user to a sign up or landing page that will describe the new rewards program and request some new information from the contact. This landing page, provided by the web server 120, will also display the contact's first name and prepopulate the email field. The contact will then have a choice of providing more contact information as well as selecting notification options (email, SMS, mail) or opting out completely from the program.

The mailings will provide the contact with a generic URL that will direct the contact to a generic sign up page, provided by the web server 120. This page will not be pre-populated with the contact information, but may look identical in all other aspects to the personalized URL. This page will collect the same information as the personalized URL page, but will include fields to add an email address.

Once the campaign is created using the marketing system 105, the contact list is attached to the campaign and the desired channels are selected. The user will create the productions by adding the collateral as well as by applying the VCRs, which are various types of rules for the content and productions. The VCRs for the outbound channels are created as follows: (a) if contact has an email address, send email production with a personalized URL; and (b) if contact does not have an email address, send direct mailer to home address with a generic URL.

The production is completed by the user and reviewed. Once reviewed, the campaign may be sent for approval(s). Administrators of the marketing system 105 may provide approvals. The administrators may be marketing professionals. Once the approvals are obtained, the campaign is deployed to the contacts based on a schedule. For example, the productions may be sent in intervals, or beginning at a date and time.

The information received back from the contacts via inbound channels and other responses will be: (a) how many people opened the email, who opened it and when (detectable by read receipts sent to the marketing system 105 or by tracking images placed in the email and detectable by the marketing system 105); (b) who did not open the email; (c) who used the provided URL; (d) who did not use the provided URL; (e) who provided an email address via a landing page; (f) who provided updated contact information; (g) who opted in and to what; and (h) who opted out; among other things.

During another example operation of the marketing system 105, All New Clothing Company has decided to send out a $25 off coupon to all its customers or contacts. These contacts have been gathered through email signups on their website over the past 5 years of being in business. The contacts have been given the option of choosing how they would like to be contacted for promotions. The customer list has grown to over 2.5 million contacts.

All New Clothing Company needs to put together a campaign to reach all of the contacts through the most cost effective distribution channels to get the contacts in the stores to see and purchase items from the new Spring line. All New Clothing Company, the user, knows that email is the most cost effective solution, but will need to make sure that customers that do not respond to the email campaign have another option available to them. This will be accomplished by a delayed direct mailing only to those customers that do not respond to the email campaign within one week.

Using the marketing system 105, the user will first select the contact list containing all the available contacts for All New Clothing Company. The selected contact list will display the total number of records contained within the chosen list. For this list, the user sees that there are 2,600,000 contacts. The user then selects an item for the outbound channel, which is an email production, and drags it onto a work space. The user will then select the production and apply the filters to the production that will ensure only people with email receive the email. The user will also set the filter to not send any emails to any customers that have opted out of email campaigns.

Once the email production is set, the user sees that 2,000,000 contacts will receive the email. This leaves 600,000 contacts that still need to receive the coupon. The user selects another outbound channel, which is SMS. Utilizing the same process as before, the user selects the appropriate contact filters for that channel (i.e., must have a text message number as well has must have opted in to receive text messages). The count shows that 550,000 contacts will receive the SMS message via the SMS system 135. For the remaining 50,000 contacts, the user may address them later in the campaign creation process.

Now that the outbound channels have been configured for 98% of the contacts on the list, the user is ready to configure how the contacts will actually get the coupon. The coupon will be distributed by a link to a landing page (i.e., provided by the web server 120) that will be displayed within the email or SMS productions that the contact receives. This is the action item for the contact. The user selects “Landing Page” as the inbound channel and configures it to be a personalized URL to each of the contacts. The link takes the contact directly to a page with a barcoded coupon. The image for the coupon is collateral, provided by the user, that is added to the landing page. Once a contact accesses the coupon online, the coupon is no longer available on that page and the page will display a message that informs the contact that the offer is no longer available.

The user configures a secondary outbound channel for customers who do not access the personalized URL within one week. The secondary outbound production will be a direct mailing of a $10 off coupon. The user configures the channel to only send the mailing to contacts with valid US mailing addresses who are (a) contacts that have not accessed the original offer via the personalized URL within the past week; or (b) contacts that did not receive the original offer by email or SMS (i.e., the 50,000 “left over” contacts). The user once again selects the appropriate collateral for the mailing (which in this case is a physical postcard with the image of the $10 coupon printed on it and a personalized barcode).

The campaign is now ready to deploy and the user configures the date and time that the outbound channels should be deployed, as well as when the link (i.e., the personalized URL) should be activated as well as deactivated. Next, the user configures the time and date that the secondary outbound channel (i.e., the direct mail) should be sent out (i.e., one week from date of the email/SMS). The campaign may then be reviewed, and deployed after approvals are received.

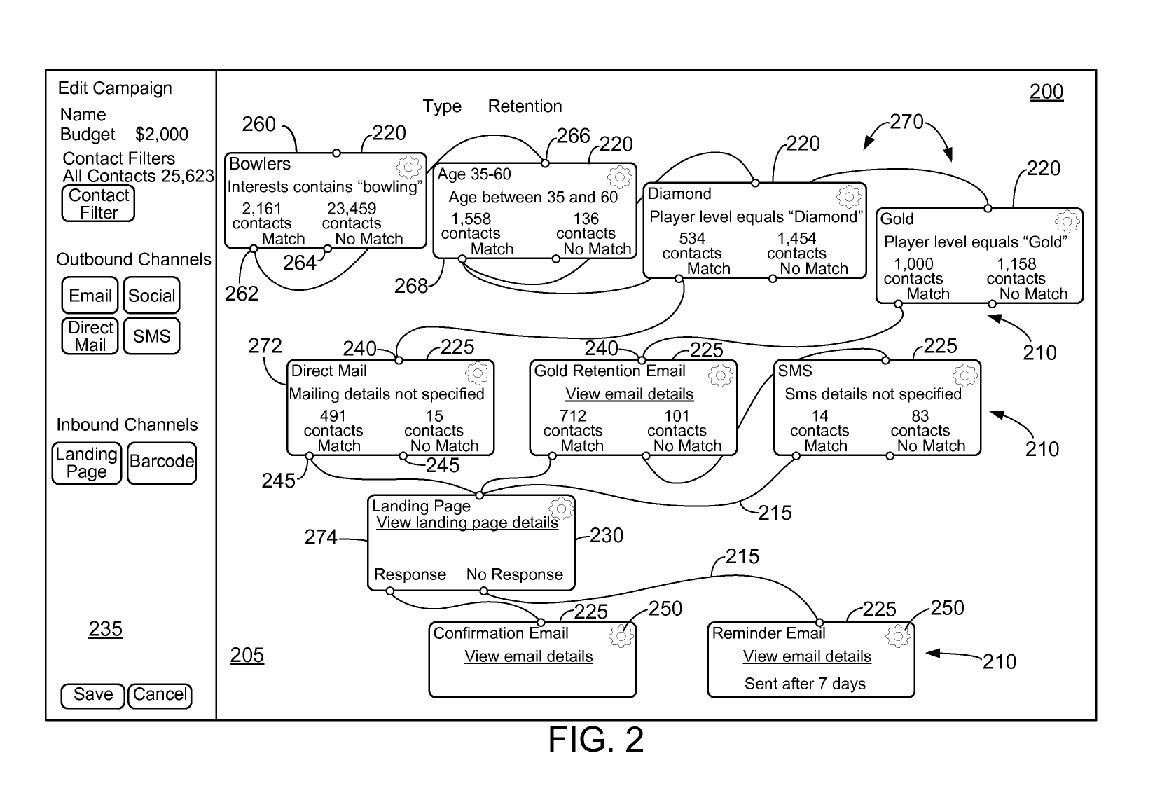

FIG. 2 is an exemplary interface 200 for use with the marketing system 105 (shown in FIG. 1). In the exemplary embodiment, the interface 200 is web-based, however other implementations, such as mobile apps, are possible. The interface 200 is a graphical user interface. A work space 205 is provided for creating and organizing a campaign. Within the work space 205 are objects 210 (shown as boxes) and connectors 215 (shown as lines) that connect one or more objects 210. The objects 210 may be contact list live queries 220, outbound channels 225, and inbound channels 230. The objects 210 may be dragged onto the work space 205 from a tool bar 235.

Objects 210 may have one or more inputs 240 and one or more outputs 245. Data flows from outputs 245 to inputs 240 via connectors 215. Objects 210 may be customized by clicking on a details icon 250. Customizing an object 210 may include providing collateral, creating or modifying productions, filtering data, providing VCRs, etc.

In the example shown in FIG. 2, a first contact live query 260 restricts a campaign contact list to contacts whose interests include “bowling.” A first output 262 of the first contact live query 260 represents matches, and a second output 264 represents non-matches. The first output 262 is connected to an input 266 of a second contact live query 268. In other words, the matches of the first contact live query 260 flow into the second contact live query 268. Other inputs 240, outputs 245, and connectors 215 operate similarly.

All contacts whose interests include “bowling” who are also between the ages of 35 and 60 are supplied to additional contact live queries 270. As shown, diamond-level players are fed into a first outbound channel 272, which is direct mail. The first outbound channel 272 includes a production (not shown) that includes collateral. The collateral may include a URL to a first inbound channel 274, which is a landing page. Diamond-level players without a mailing address or otherwise satisfying the conditions of the first outbound channel 272 will not receive a mailing as the non-matching contacts do not flow anywhere.

The gold-level players will receive an email if an email address is available, and will receive a SMS if an email address is not available but a SMS-capable number is available. If neither an email address nor a SMS-capable number is available for a gold-level player, the gold-level player will not receive a production. Similar to the direct mail of the first outbound channel 272, the email and the SMS may include collateral that may be customized using VCRs. The collateral may be customized using personalized fields. Both the email and the SMS message include a link to the first outbound channel. By connecting outbound channels 225 to inbound channels 230, the marketing system 105 creates an association therebetween and is thereby capable of receiving responses via the inbound channel 230 and associating the responses with the outbound channel 225, a production, and the campaign.

If contacts respond to the first inbound channel 274, a confirmation email is sent. The confirmation email is a production and may be customized If a contact has not responded to the first inbound channel 274 after 7 days by visiting the landing page and/or inputting information on the landing page, a reminder email is sent to the contact. The reminder email is a production and can be customized.

Connectors 215 can be drawn between objects 210 by clicking and dragging. Within the work space 205, objects 210 and connectors 215 can be rearranged without affecting the campaign. The marketing system 105 translates objects 210 and connectors 215 into a campaign definition that includes at least one campaign contact list, one or more productions, one or more outbound channels, and/or one or more inbound channels. Connectors 215 create associations between channels, and can be used by the marketing system 105 to detect responses and monitor the campaign. Objects 210 may cause the marketing system 105 to interact with other components of the system 100 (shown in FIG. 1) to collect contact lists, transmit productions, e.g., to email system 130, and monitor responses. The user of interface 200 may thus create, manage, and measure a marketing campaign. The marketing system 105 generates contact lists, customizes productions, transmits productions to contacts, and creates associations with productions such that responses can be detected and stored. More specifically, the marketing system 105 will turn outbound channels 225 into actual emails, SMS, direct mail, etc. by communication with the system 100. For example, if the user has provided social media login credentials to the marketing system 105, the marketing system 105 may post content based on a production to the social media system 150 without user intervention.

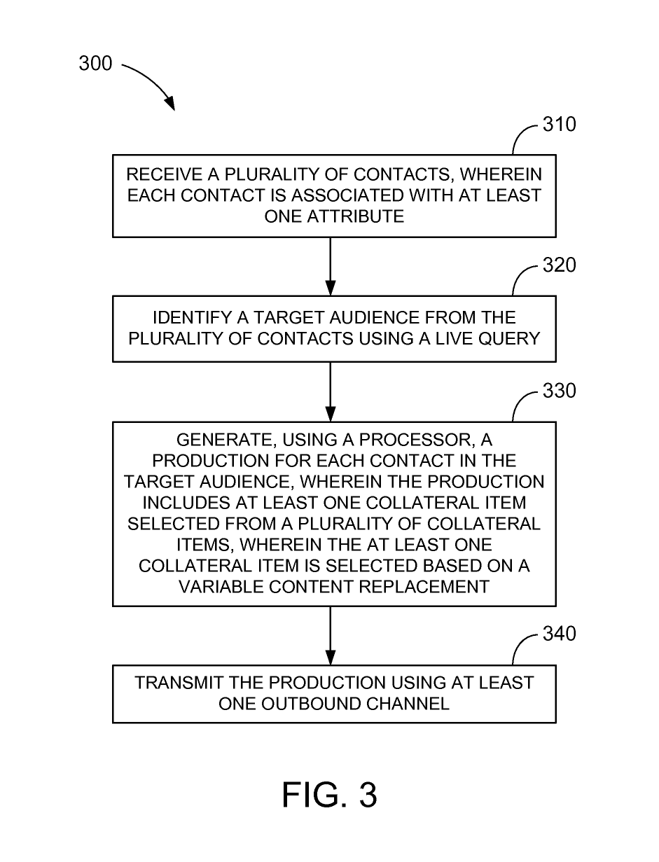

FIG. 3 is a flowchart of an exemplary method 300 for creating and managing marketing campaigns using the marketing system 105 (shown in FIG. 1). In operation 310, the marketing system 105 provides a plurality of contacts, wherein each contact is associated with at least one attribute. The attributes may be any data associated with a contact, such as contact information, name(s), gender, age, birthday, and other profile information. The attributes enable a target audience within the plurality of contacts to be identified. In operation 320, the marketing system 105 identifies a target audience from the plurality of contacts based on the at least one attribute. Boolean or other logical operators may be used alone, or in combination, to identify the target audience from the plurality of contacts.

In operation 330, the marketing system 105 generates, using a processor, a production for each contact in the target audience. The target audience are those contacts identified by the live query process. The production includes at least one collateral item selected from a plurality of collateral items, wherein the at least one collateral item is selected based on a variable content replacement. In other words, the production may be customized using different collateral items that are selected based on variable content replacement. In operation 340, the marketing system 105 transmits the production using at least one outbound channel. An inbound channel may be provided that is associated with the outbound channel. A response to the production may be detected by the marketing system 105 via the inbound channel. The production may be transmitted with an identifier that associates the at least one outbound channel with the inbound channel. The inbound channel may be a landing page. The outbound channel may be email, direct mail, and mobile device communication messages, such as SMS messages. Different outbound channels can be used for the plurality of contacts. Moreover, an outbound channel can be selected for a contact based on whether the contact has responded to the outbound channel in the past.

In some embodiments, the marketing system 105 provides a graphical user interface, wherein at least one relationship can be formed between the plurality of contacts and the at least one outbound channel using the graphical user interface. Relationships can also be formed between the at least one outbound channel and the inbound channel. Relationships may be created in the graphical user interface using connectors.

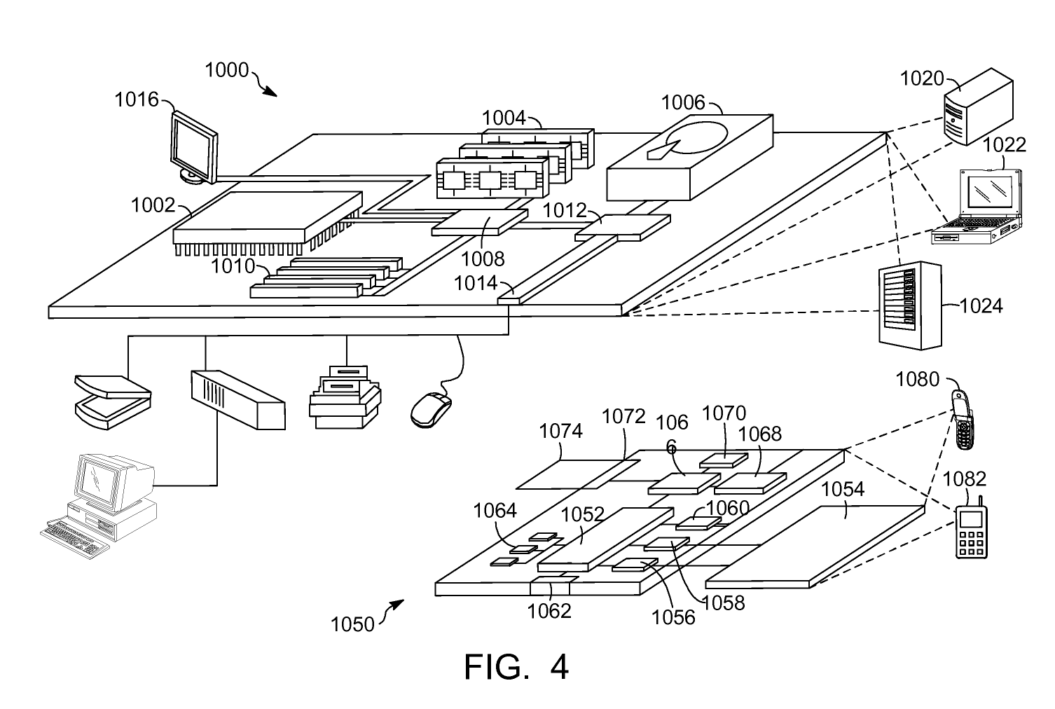

FIG. 4 is a block diagram showing example or representative computing devices and associated elements that may be used to implement the systems of FIG. 1. FIG. 4 shows an example of a generic computing device 1000 and a generic mobile computing device 1050, which may be used with the techniques described here. Computing device 1000 is intended to represent various forms of digital computers, such as laptops, desktops, workstations, personal digital assistants, servers, blade servers, mainframes, and other appropriate computers. Computing device 1050 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 1000 includes a processor 1002, memory 1004, a storage device 1006, a high-speed interface or controller 1008 connecting to memory 1004 and high-speed expansion ports 1010, and a low-speed interface or controller 1012 connecting to low-speed bus 1014 and storage device 1006. Each of the components 1002, 1004, 1006, 1008, 1010, and 1012, are interconnected using various busses, and may be mounted on a common motherboard or in other manners as appropriate. The processor 1002 can process instructions for execution within the computing device 1000, including instructions stored in the memory 1004 or on the storage device 1006 to display graphical information for a GUI on an external input/output device, such as display 1016 coupled to high-speed controller 1008. In other implementations, multiple processors and/or multiple buses may be used, as appropriate, along with multiple memories and types of memory. Also, multiple computing devices 1000 may be connected, with each device providing portions of the necessary operations (e.g., as a server bank, a group of blade servers, or a multi-processor system).

The memory 1004 stores information within the computing device 1000. In one implementation, the memory 1004 is a volatile memory unit or units. In another implementation, the memory 1004 is a non-volatile memory unit or units. The memory 1004 may also be another form of computer-readable medium, such as a magnetic or optical disk.

The storage device 1006 is capable of providing mass storage for the computing device 1000. In one implementation, the storage device 1006 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1004, the storage device 1006, or memory on processor 1002.

The high-speed controller 1008 manages bandwidth-intensive operations for the computing device 1000, while the low-speed controller 1012 manages lower bandwidth-intensive operations. Such allocation of functions is exemplary only. In one implementation, the high-speed controller 1008 is coupled to memory 1004, display 1016 (e.g., through a graphics processor or accelerator), and to high-speed expansion ports 1010, which may accept various expansion cards (not shown). In the implementation, low-speed controller 1012 is coupled to storage device 1006 and low-speed bus 1014. The low-speed bus 1014, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1020, or using a group of such servers. It may also be implemented as part of a rack server system 1024. In addition, it may be implemented in a personal computer such as a laptop computer 1022. Alternatively, components from computing device 1000 may be combined with other components in a mobile device (not shown), such as device 1050. Each of such devices may contain one or more of computing device 1000, 1050, and an entire system may be made up of multiple computing devices 1000, 1050 communicating with each other.

Computing device 1050 includes a processor 1052, memory 1064, an input/output device such as a display 1054, a communication interface 1066, and a transceiver 1068, among other components. The device 1050 may also be provided with a storage device, such as a microdrive or other device, to provide additional storage. Each of the components 1050, 1052, 1064, 1054, 1066, and 1068, are interconnected using various buses, and several of the components may be mounted on a common motherboard or in other manners as appropriate.

The processor 1052 can execute instructions within the computing device 1050, including instructions stored in the memory 1064. The processor may be implemented as a chipset of chips that include separate and multiple analog and digital processors. The processor may provide, for example, for coordination of the other components of the device 1050, such as control of user interfaces, applications run by device 1050, and wireless communication by device 1050.

Processor 1052 may communicate with a user through control interface 1058 and display interface 1056 coupled to a display 1054. The display 1054 may be, for example, a Thin-Film-Transistor Liquid Crystal Display (TFT LCD) or an Organic Light Emitting Diode (OLED) display, or other appropriate display technology. The display interface 1056 may comprise appropriate circuitry for driving the display 1054 to present graphical and other information to a user. The control interface 1058 may receive commands from a user and convert them for submission to the processor 1052. In addition, an external interface 1062 may be provide in communication with processor 1052, so as to enable near area communication of device 1050 with other devices. External interface 1062 may provide, for example, for wired communication in some implementations, or for wireless communication in other implementations, and multiple interfaces may also be used.

The memory 1064 stores information within the computing device 1050. The memory 1064 can be implemented as one or more of a computer-readable medium or media, a volatile memory unit or units, or a non-volatile memory unit or units. Expansion memory 1074 may also be provided and connected to device 1050 through expansion interface 1072, which may include, for example, a Single In Line Memory Module (SIMM) card interface. Such expansion memory 1074 may provide extra storage space for device 1050, or may also store applications or other information for device 550. Specifically, expansion memory 1074 may include instructions to carry out or supplement the processes described above, and may include secure information also. Thus, for example, expansion memory 1074 may be provide as a security module for device 1050, and may be programmed with instructions that permit secure use of device 1050. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1064, expansion memory 1074, or memory on processor 1052, that may be received, for example, over transceiver 1068 or external interface 1062.

Device 1050 may communicate wirelessly through communication interface 1066, which may include digital signal processing circuitry where necessary. Communication interface 1066 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1068. In addition, short-range communication may occur, such as using a Bluetooth, Wife, or other such transceiver (not shown). In addition, Global Positioning system (GPS) receiver module 1070 may provide additional navigation- and location-related wireless data to device 1050, which may be used as appropriate by applications running on device 1050.

Device 1050 may also communicate audibly using audio codec 1060, which may receive spoken information from a user and convert it to usable digital information. Audio codec 1060 may likewise generate audible sound for a user, such as through a speaker, e.g., in a handset of device 1050. Such sound may include sound from voice telephone calls, may include recorded sound (e.g., voice messages, music files, etc.) and may also include sound generated by applications operating on device 1050.

The computing device 1050 may be implemented in a number of different forms, as shown in the figure. For example, it may be implemented as a cellular telephone 1080. It may also be implemented as part of a smart phone 1082, personal digital assistant, a computer tablet, or other similar mobile device.

Thus, various implementations of the systems and techniques described here can be realized in digital electronic circuitry, integrated circuitry, specially designed application specific integrated circuits (ASICs), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a cathode ray tube (CRT) or liquid crystal display (LCD) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system (e.g., computing device 1000 and/or 1050) that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In the example embodiment, computing devices 1000 and 1050 are configured to receive and/or retrieve electronic documents from various other computing devices connected to computing devices 1000 and 1050 through a communication network, and store these electronic documents within at least one of memory 1004, storage device 1006, and memory 1064. Computing devices 1000 and 1050 are further configured to manage and organize these electronic documents within at least one of memory 1004, storage device 1006, and memory 1064 using the techniques described herein.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included. For example, while marketing campaigns have been referred to throughout, other applications of the above embodiments include online or web-based applications or other cloud services.

Also, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “identifying” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments of the invention may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-implemented method comprising:
receiving a plurality of contact records, wherein each contact record is associated with at least one attribute;
identifying a target audience from the plurality of contacts records using a live query, wherein the target audience includes one or more contact records from the plurality of contact records;
generating, using a processor, a production for each contact record in the target audience, wherein the production includes at least one collateral item selected from a plurality of collateral items, wherein the at least one collateral item is selected based on a variable content replacement, wherein the variable content replacement includes at least one rule; and
transmitting the production using at least one outbound channel.

2. The method of claim 1, further comprising providing an inbound channel that is associated with the at least one outbound channel.

3. The method of claim 2, further comprising detecting a response to the production via the inbound channel.

4. The method of claim 3, further comprising providing a graphical user interface, wherein at least one relationship is formed between the plurality of contacts and the at least one outbound channel using the graphical user interface.

5. The method of claim 3, further comprising providing a graphical user interface, wherein at least one relationship is formed between the at least one outbound channel and the inbound channel using the graphical user interface.

6. The method of claim 5, wherein transmitting the production comprises transmitting an identifier that associates the at least one outbound channel with the inbound channel.

7. The method of claim 2, wherein the inbound channel is a landing page.

8. The method of claim 1, wherein the at least one outbound channel includes at least one of email, direct mail, and mobile device communication messages.

9. The method of claim 1, wherein transmitting the production using at least one outbound channel comprises determining an outbound channel for each contact record.

10. The method of claim 9, wherein determining an outbound channel for each contact record comprises determining an outbound channel based on a contact response.

11. A marketing system comprising a processing device programmed to:
receive a plurality of contact records, wherein each contact record is associated with at least one attribute;
identify a target audience from the plurality of contacts using a live query, wherein the target audience includes one or more contact records from the plurality of contact records;
generate a production for each contact record in the target audience, wherein the production includes at least one collateral item selected from a plurality of collateral items, wherein the at least one collateral item is selected based on a variable content replacement, wherein the variable content replacement includes at least one rule; and
transmit the production using at least one outbound channel.

12. The marketing system of claim 11, wherein said processing device is further programmed to provide an inbound channel that is associated with the outbound channel.

13. The marketing system of claim 12, wherein said processing device is further programmed to detect a response to the production via the inbound channel.

14. The marketing system of claim 13, wherein said processing device is further programmed to provide a graphical user interface, wherein at least one relationship is formed between the plurality of contacts and the at least one outbound channel using the graphical user interface.

15. The marketing system of claim 13, wherein said processing device is further programmed to provide a graphical user interface, wherein at least one relationship is formed between the at least one outbound channel and the inbound channel using the graphical user interface.

16. The marketing system of claim 15, wherein transmitting the production comprises transmitting an identifier that associates the at least one outbound channel with the inbound channel.

17. The marketing system of claim 11, wherein transmitting the production using at least one outbound channel comprises determining an outbound channel for each contact.

18. One or more non-transitory computer-readable storage media having computer-executable instructions embodied thereon, wherein when executed by at least one processing device, said computer-executable instructions cause the at least one processing device to:
receive a plurality of contact records, wherein each contact record is associated with at least one attribute;
identify a target audience from the plurality of contacts using a live query, wherein the target audience includes one or more contact records from the plurality of contact records;
generate a production for each contact record in the target audience, wherein the production includes at least one collateral item selected from a plurality of collateral items, wherein the at least one collateral item is selected based on a variable content replacement, wherein the variable content replacement includes at least one rule; and
transmit the production using at least one outbound channel.

19. The non-transitory computer-readable storage media of claim 18, wherein the computer-executable instruction further cause the at least one processing device to provide a graphical user interface, wherein at least one relationship is formed between the plurality of contacts and the at least one outbound channel using the graphical user interface.

20. The non-transitory computer-readable storage media of claim 19, wherein the computer-executable instruction further cause the at least one processing device to provide a graphical user interface, wherein at least one relationship is formed between the at least one outbound channel at the inbound channel using the graphical user interface.
